(19) United States
(12) Patent Application Publication
(10) Pub. No.: US 2023/0009499 A1
(43) Pub. Date: Jan. 12, 2023

(54) LEVELLING SYSTEM AND METHOD

(71) Applicant: AEROSINT, Herstal (BE)

(72) Inventors: Matthias HICK, Limbourg (BE); Martin MARCHAL, Wolkrange (BE); Peter MERCELIS, Geel (BE)

(21) Appl. No.: 17/784,911

(22) PCT Filed: Dec. 11, 2020
(86) PCT No.: PCT/EP2020/085766

§ 371 Date: Jun. 13, 2022

(30) Foreign Application Priority Data
Dec. 13, 2019 (BE) BE2019/5902

(51) Int. Cl. B29C 64/205; B29C 64/153; B29C 64/357; B29C 64/336; B29C 64/236; B33Y 10/00; B33Y 30/00

(52) U.S. Cl. CPC B29C 64/205; B29C 64/153; B29C 64/357; B29C 64/336; B29C 64/236; B33Y 10/00; B33Y 30/00

(57) ABSTRACT

A system and a method for levelling a powder bed is disclosed. The system comprises a cutting device comprising a cutting line and a support surface. The powder bed is cut by the cutting line which moves in a first direction such that the cut powder ends up in contact with the support surface, where it is drawn towards an outlet by a powder entrainment system.

### TECHNICAL FIELD

The present invention relates to a system and a method for levelling a powder bed. It can be used in particular in the context of the three-dimensional printing.

### PRIOR ART

The document WO2018/059833 describes a three-dimensional printing system by which a three-dimensional printing structure comprising a plurality of types of particles can be formed.

The document WO2018/183396 describes a method for manipulating materials in the scope of a three-dimensional printing. The method comprises a transport of pre-processed material from a reservoir. The transportation can be against the gravity.

The document WO2019/159644 describes a powder bed melting type additive manufacturing apparatus. This apparatus comprises in particular a material deposition unit that deposits and levels a material powder.

### SUMMARY OF THE INVENTION

An object of the present invention is to obtain a flat and/or horizontal powder structure from a powder bed which may be irregular in height.

An object of the present invention is to equalize a powder structure.

To this end, the invention provides a levelling system and method for levelling a powder bed.

According to a first aspect, the invention provides a levelling system for levelling a powder bed, and comprising:

a cutting device comprising a cutting line and a support surface, the cutting line being arranged to cut the powder bed so that the cut powder comes into contact with the support surface when the cutting device is displaced in a first direction relative to the powder bed, and

a powder drive system arranged so as to drive the powder in contact with the support surface towards an outlet.

In the invention, as the cutting device moves, the upper portion of the powder bed is cut by the cutting line and the powder thus removed from the powder bed comes into contact with the support surface. There, it is driven by the drive system towards the exit. This ensures that the cut powder does not return to the powder bed, either upstream or downstream of the cutting line.

Indeed, there are applications where it is very important that the lower portion of the powder bed is not altered in any way by the levelling. For example, if the powder bed comprises particles of different materials for three-dimensional printing, it would be very damaging to the physical or chemical characteristics of the object to be printed if several materials were mixed together as a result of levelling that created a mixture of different particles.

The system is preferably arranged so that the drive system drives only the powder in contact with the support surface. Thus, the powder remaining on the powder bed is not displaced. This allows to ensure that the drive system does not disturb the structure of the powder bed, in particular upstream of the cutting line.

The support surface is preferably located to the rear of the cutting line with respect to the displacement of the cutting device in the first direction. This allows the cut powder to come into contact with the support surface by inertia and/or by contact with downstream powder particles.

The cutting line is not necessarily a continuous line: it can be made of several separate line portions. The cutting line is preferably straight. The system is preferably configured so that the cutting line is horizontal. The cutting line is mechanically coupled to the support surface. The cutting line preferably forms one end of the support surface.

The support surface is not necessarily a continuous surface: it can be made of several separate surface portions. The system is preferably configured so that the support surface is inclined. The support surface can be flat or curved. If it is curved, it is preferably concave.

The levelling system preferably comprises a motion system for displacing the cutting device in the first direction relative to the powder bed. The first direction is preferably a horizontal direction.

The outlet can open, for example, towards a discharge device of the powder, a recycling system of the powder, a filtration system. The fluidic connection between the top of the support surface and the outlet is preferably powder-tight. In other words, this fluidic connection is arranged to prevent the powder from leaving it. This allows all the powder to be conducted to the outlet. The drive system is arranged to displace the powder towards the outlet, preferably, but not necessarily, to the outlet. The drive preferably forms at least one portion of a discharge of the powder.

The levelling system may comprise actuators, for example, to control the position of its various elements (e.g., elements of the cutting device and/or the drive system), their orientation, their rigidity, and/or the magnitude of the drive. In particular, the height of the cutting line can be adjusted by an actuator. The actuators can be controlled manually, automatically and/or via a software.

In the scope of this document, a forward displacement of the cutting device is a displacement relative to the powder bed and thus may be a backward displacement of the powder bed relative to the cutting device.

As used herein, the powder in contact with the support surface may, for example, be on the support surface.

In an embodiment of the invention, the levelling system further comprises a guide located at least partially apposite the support surface and arranged to channel at least one portion of the powder into contact with the support surface as it travels towards the outlet.

The guide and the cutting device thus form a channel towards the outlet. This prevents the powder from going elsewhere than towards the outlet, in particular towards the top. If the drive is by suction, it also allows to channel the suction.

In an embodiment of the invention, the drive system comprises a suction device arranged to suck at least one portion of the powder in contact with the support surface towards the outlet. The support surface is then preferably smooth.

In an embodiment of the invention, the drive system comprises a sweeping device arranged to push at least one portion of the powder in contact with the support surface towards the outlet. The sweeping device is preferably located within 2 mm of the cutting line to avoid a powder build-up that could cause a clogging and/or levelling with trenches.

If the levelling system comprises a guide, the sweeping device is preferably arranged to push the powder into the channel formed by the guide and the cutting device.

Preferably, the sweeping device comprises a rotating shaft and a plurality of radial elements arranged to be driven in rotation by the rotating shaft and arranged to push the at least one portion of the powder in contact with the support surface towards the outlet.

Preferably, the support surface is arranged to prevent at least one portion of the powder in contact with the support surface from moving towards the powder bed. For example, the support surface comprises indentations blocking the powder in contact with the support surface. The indentations are preferably asymmetrical so that, for powder in an indentation, the slope corresponding to a displacement towards the outlet is less than the slope corresponding to a displacement towards the powder bed. It is also possible that roughness, asperities or irregularities of the support surface provide the blockage.

In an embodiment of the invention, the drive system comprises a mechanism for allowing an oscillation along the first direction of the support surface. Preferably, said oscillation along the first direction is such that it progressively advances, or assists in advancing, at least one portion of the powder in contact with the support surface towards the outlet. For example, in the oscillation in the first direction, the forward acceleration may be greater than the backward acceleration. Thus, since the frictional force with a plane does not depend on the speed of friction (as long as the object is moving), more motion can be imparted to the particles on the return motion of the support surface (which lasts longer) than on the forward motion (which lasts shorter). The oscillation in the first direction also allows to facilitate the cutting by fluidizing the powder.

In an embodiment of the invention, the drive system comprises a mechanism for allowing an oscillation along a third direction of the support surface, the third direction being vertical. Preferably, said oscillation along the third direction is such that it progressively advances, or assists in advancing, at least one portion of the powder in contact with the support surface towards the outlet.

The vertical oscillations allow to transmit a vertical impulse to the powder, in order to detach it from the surface, which helps to drive it.

In an embodiment of the invention, the drive system comprises a mechanism for allowing a combination of oscillations along the first and a third direction of the support surface, the third direction being vertical. Preferably, said combination of oscillations is such as to progressively advance, or assist in advancing, at least one portion of the powder in contact with the support surface towards the outlet.

The combination of oscillations is preferably such that the intersection of the cutting line with a vertical plane makes a motion that is a combination of a circular motion in that plane and a forward motion. This allows the powder to jump and then fall back onto the support surface, so that the jumps and falls form a motion of the powder towards the outlet. A jump drive is used in particular in the vibrating bowls.

In an embodiment of the invention, the cutting line is located on a foldable portion of the cutting device, said foldable portion being arranged to fold and/or rotate so that the cutting line rises when the cutting line encounters an obstacle. In other words, thanks to the foldable portion, the cutting line displaces vertically when it meets an obstacle. This allows to avoid breaking the cutting device or displacing the obstacle which may be an object during printing. The foldable portion is preferably attached to a device body, which is displaced in the first direction. When the cutting line encounters an obstacle, the device body continues the motion in the first direction while the foldable portion folds so that the cutting line rises, preferably scraping the top of the obstacle. For example, the foldable portion may be flexible, and preferably more flexible than the body of the device, and/or may be rigid and arranged to pivot relative to the body of the device, and for example held in place by a return element (in particular a spring) that allows it to return to the cutting position.

In an embodiment of the invention, the foldable portion comprises a first portion on which the cutting line and at least one portion of the support surface are located, and a second portion forming a non-zero angle, preferably an acute angle, with the first portion, the cutting device being arranged so that the foldable portion is adapted to pivot about a pivot located forward of the cutting line relative to the displacement of the cutting device. This positioning of the pivot allows the cutting line to be raised when it meets an obstacle. The pivot may be a hinge or an intrinsic folding axis of the part comprising the second portion. The pivot preferably forms an axis of rotation extending in the second direction.

The support surface preferably comprises a first portion, which comprises the cutting line (and the foldable portion if present), and a second portion, which is on the device body. In one embodiment, the two portions of the support surface are continuous with each other.

In one embodiment of the invention, the cutting device comprises a curved blade arranged such that at least one portion of the support surface is concave. The blade is preferably thinner than the body of the device, which allows it to be more flexible. The blade can be mounted on the body of the device by a hinge. Preferably, the foldable portion of the cutting device comprises a curved blade arranged such that at least one portion of the support surface is concave.

In an embodiment of the invention, the foldable portion of the cutting device comprises independently foldable elements, for example bristles or slats, distributed along a second direction perpendicular to the first direction. The second direction is preferably a horizontal direction. When the cutting line encounters an obstacle whose height varies according to the second direction, the foldable elements that touch the obstacle fold, while the foldable elements that do not touch it continue to cut according to the initial height.

In an embodiment of the invention, the independently foldable elements are slats, to which are attached extension elements forming the cutting line, the extension elements being more extended than the slats along the second direction and being more flexible than the slats. The extension elements allow to improve the tightness of the cutting: it allows to have a particularly flat surface.

In one embodiment of the invention, the levelling system further comprises a blower arranged to blow on the powder of the powder bed and/or on the powder in contact with the support surface. When the blower blows on the powder of the powder bed, it allows to sets the upper layers of the powder bed in motion, making them easier to cut. When the blower blows on the powder in contact with the support surface, it helps to drive the powder towards the outlet.

In one embodiment of the invention, the levelling system comprises an actuator arranged to change the height of the cutting line. In other words, the actuator allows the cutting line to be translated in the third direction. This allows to change the height of the powder bed without having to displace the horizontal support

In an embodiment of the invention, the cutting device is a first cutting device, the cutting line is a first cutting line and the support surface is a first support surface, the levelling system further comprises a second cutting device comprising a second cutting line and a second support surface, the second cutting line is arranged to cut the powder bed so that the cut powder comes into contacts with the second support surface when the second cutting device is displaced in the first direction relative to the powder bed, the second cutting line is lower than the first cutting line, behind the first cutting line with respect to the displacement of the cutting devices, and preferentially parallel to the first cutting line. There can be more than two successive cutting devices while remaining within the scope of the invention. This allows to ensure that each of the cutting devices does not receive too much cut powder.

The invention further provides a three-dimensional printing system comprising:

a deposition device arranged to deposit at least one powder so as to form a powder bed,

a levelling system according to any embodiment of the invention arranged to level said powder bed, and

an agglomerating means arranged to agglomerate at least one portion of said powder bed after said powder bed has been levelled by said levelling system.

The levelling system is preferably coupled to the deposition device. The agglomerating means may comprise at least one of: an oven, a laser, an electron beam, a laser equipped with a sweeping system to be able to heat the whole powder bed, a halogen lamp, a means for generating a local or uniform chemical reaction. The agglomeration can be done afterwards (after deposition of a volume), by uniform sintering (thermal treatment), by binder jet, infiltration, chemical reaction, compaction, etc.

In an embodiment of the invention, the deposition device is arranged to deposit the at least powder onto the powder bed without contacting said powder bed. The combination of such a deposition device with a levelling system according to the invention allows to disturb particularly little, if any, the powder layers and the portions of the objects printed underneath.

In an embodiment of the invention, the deposition device is arranged to deposit the at least powder onto the powder bed at selected locations of said powder bed.

In one embodiment of the invention, the deposition device is arranged to deposit a plurality of powders at selected locations, so as to form a powder bed comprising different powders, for example of different materials and/or different particle sizes. Thus, the different powders are at different locations in the powder bed.

According to a second aspect, the invention provides a levelling method for levelling a powder bed, the method comprising the steps of:
providing the powder bed,
providing a cutting device comprising a cutting line and a support surface,
cutting the powder bed with the cutting line by displacing the cutting device in a first direction relative to the powder bed so that the cut powder comes into contact with the support surface, and
driving the powder into contact with the support surface towards an outlet.

The advantages mentioned for the system apply mutatis mutandis to the method. The method preferably comprises providing a levelling system according to any one embodiment of the invention.

The invention further provides a three-dimensional printing method comprising:
a formation of a powder bed,
a levelling of the powder bed according to the method of the previous claim, and
an agglomeration of at least one portion of said powder bed after levelling.
   The levelling can occur after each powder deposit or after several powder deposits. The agglomeration can occur after each levelling or after several repetitions of both powder deposition and levelling steps. For example, the agglomeration can be achieved after the creation of a powder bed that comprises the entire powder that will become the printed object.

The invention further provides a method for forming a powder structure comprising, in this order:
a deposit, using a first deposition device, of a first powder to form a first powder bed portion,
a levelling of the first powder bed portion using a first levelling system which is, for example, as described herein,
a deposit, by means of a second deposition device, of a second powder to form a second powder bed portion, and
a levelling of the second powder bed portion using a second levelling system which is, for example, as described herein,
wherein the levelling of the first powder bed portion and the levelling of the second powder bed portion are vertically aligned.
   The method can comprise 3 deposits and 3 levelling systems, 4 deposits and 4 levelling systems, or more. The number of deposition devices may or may not be equal to the number of levelling systems.

The invention further provides a method for creating a powder form comprising, in this order:
a first powder deposit, with a first definition, to form a first portion of the shape,
a second powder deposit, with a second definition, to form a second portion of the shape, which is partially superimposed on the first portion of the shape, and
a levelling, for example using a levelling system as described herein, of the second portion of the shape superimposed on the first portion of the shape,
in which the second definition is lower than the first definition.
   A levelling can also take place between the first and the second powder deposits.

As used herein, the first powder and the second powder are preferably different. Preferably, at least one of the following characteristics differs between the first powder and the second powder: their size distribution, their material, their shape, their colour, their Young's modulus, their density, their thermal conductivity, their electrical conductivity, their magnetic permeability, their corrosion resistance, their hardness, their melting temperature, their solubility, their combustibility, their hydrophobicity, their chemical composition.

### BRIEF DESCRIPTION OF FIGURES

Further characteristics and advantages of the invention will become apparent from the following detailed description, for the understanding of which reference is made to the appended figures, among which:

FIG. 1 is a schematic cross-sectional view of at least one portion of a levelling system according to a first embodiment of the invention,

FIG. 2 is a schematic cross-sectional view of at least one portion of a levelling system according to a second embodiment of the invention,

FIG. 3a is a schematic cross-sectional view of at least one portion of a levelling system according to a third embodiment of the invention,

FIG. 3b shows the velocity in the first direction of the cutting line as a function of time, in one embodiment of the invention,

FIG. 3c is a schematic cross-sectional view of at least one portion of a levelling system according to a fourth embodiment of the invention,

FIG. 3d is a schematic cross-sectional view of at least one portion of a levelling system according to a fifth embodiment of the invention,

FIG. 3e shows the position of the cutting line in the third direction as a function of the position in the first direction, in a levelling system according to the fifth embodiment of the invention,

FIG. 4a is a schematic cross-sectional view of at least one portion of a levelling system according to a sixth embodiment of the invention,

FIG. 4b is a schematic, three-dimensional view of at least one portion of a cutting device used in the sixth embodiment of the invention,

FIG. 5a is a schematic cross-sectional view of at least one portion of a levelling system according to a seventh embodiment of the invention,

FIG. 5b is a schematic, three-dimensional view of at least one portion of a cutting device used in the seventh embodiment of the invention,

FIG. 6a is a schematic top view of at least one portion of a cutting device according to an eighth embodiment of the invention,

FIG. 6b is a schematic cross-sectional view of at least one portion of a cutting device used in the eighth embodiment of the invention,

FIG. 7 is a schematic cross-sectional view of at least one portion of a levelling system according to a ninth embodiment of the invention,

FIG. 8a is a schematic cross-sectional view of at least one portion of a levelling system according to a tenth embodiment of the invention,

FIG. 8b is a schematic cross-sectional view of at least one portion of a levelling system according to an eleventh embodiment of the invention,

FIG. 9 is a schematic cross-sectional view of at least one portion of a levelling system according to a twelfth embodiment of the invention,

FIG. 10 is a schematic cross-sectional view of at least one portion of a levelling system according to a thirteenth embodiment of the invention,

FIG. 11 is a schematic cross-sectional view illustrating the reaction of a foldable portion of a cutting device according to an embodiment of the invention when the cutting line encounters an obstacle,

FIGS. 12a and 12b are schematic cross-sectional views of what might happen when a foldable portion of a cutting device according to one embodiment of the invention encounters an obstacle,

FIGS. 13a and 13b are schematic cross-sectional views of what might happen when a foldable portion of a cutting device according to another embodiment of the invention encounters an obstacle,

FIG. 14 is a schematic cross-sectional view of at least one portion of a levelling system according to a fourteenth embodiment of the invention,

FIG. 15 is a schematic cross-sectional view of at least one portion of a levelling system according to a fifteenth embodiment of the invention,

FIG. 16 is a schematic cross-sectional view of at least one portion of a levelling system according to a sixteenth embodiment of the invention,

FIG. 17 is a schematic cross-sectional view of at least one portion of a levelling system according to a seventeenth embodiment of the invention,

FIG. 18 illustrates, very schematically, a powder recycling system into which an outlet of a levelling system according to the invention may open,

FIG. 19 is a block diagram of a three-dimensional printing system according to an embodiment of the invention,

FIGS. 20a, 20b, 20c are schematic top views of a method for operating a levelling system,

FIGS. 21a, 21b, 21c are schematic cross-sectional views of said operating method,

FIG. 22 is a cross-sectional view illustrating a method for forming a powder structure comprising two powders, and

FIGS. 23a, 23b are cross-sectional views illustrating a method for forming a powder structure.

### EMBODIMENTS OF THE INVENTION

The present invention is described with particular embodiments and references to figures but the invention is not limited thereby. The drawings or figures described are only schematic and are not limiting.

In the context of this document, the terms “first” and “second” are used only to differentiate the various elements and do not imply an order between these elements.

In the figures, the identical or similar elements may have the same references.

This document refers to a first 201, a second 202, and a third 203 directions that are all perpendicular to each other. Preferably, the first 201 and the second 202 directions are horizontal and the third direction 203 is vertical. The third direction 203 can also be referred to as “height”.

FIGS. 1 to 19 illustrate various embodiments of the invention. The invention relates to a levelling system 1 and a method for levelling a powder bed 91. The powder bed 91 preferably comprises different particles, for example of different materials. It preferably rests on a horizontal support 90. The levelling system 1 comprises a cutting device 10 for cutting the upper portion of the powder bed 91 and a drive system 2 (FIG. 19) for driving the cut powder towards an outlet 5, so as to prevent the cut powder from falling back onto the powder bed 91.

The cutting device 10 comprises a cutting line 11 and a support surface 17. As the cutting device 10 is displaced 101 in the first direction 201, i.e., forward, the cutting line 11 slices the powder bed 91 so as to level it. Thus, behind the cutting line 11, the surface of the powder bed 91 is flat and/or horizontal. The cutting line 11 is preferably parallel to the second direction 202. Preferably, the cutting line 11 extends, along the second direction 202, from one end of the powder bed 91 to the other.

When the cut powder is disengaged from the powder bed 91 by the cutting line 11, it comes into contact with the support surface 17. The drive system 2 then drives it 102 towards the outlet 5. The motion towards the outlet 102 preferably comprises a backward component (i.e., along the first direction 201) and an upward component (i.e., along the third direction 203).

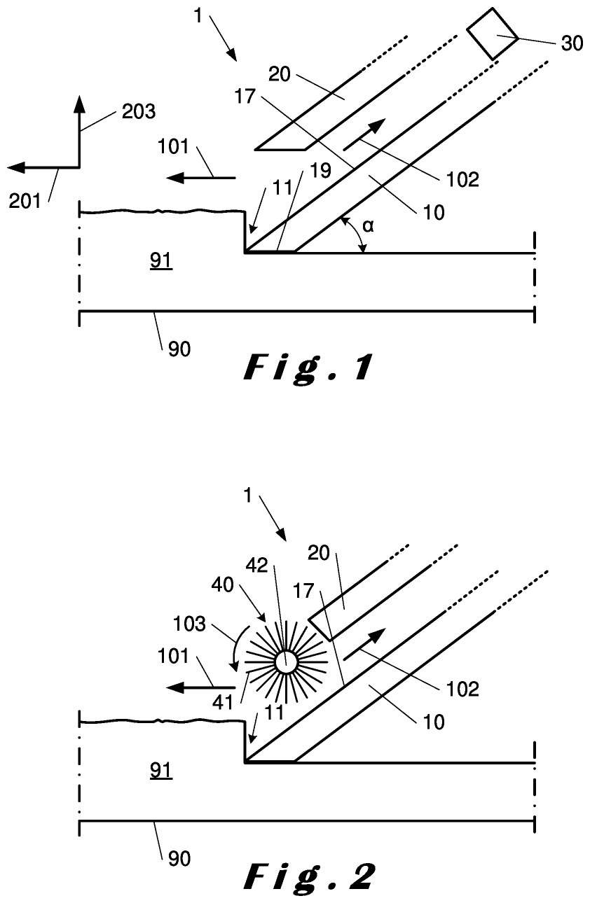

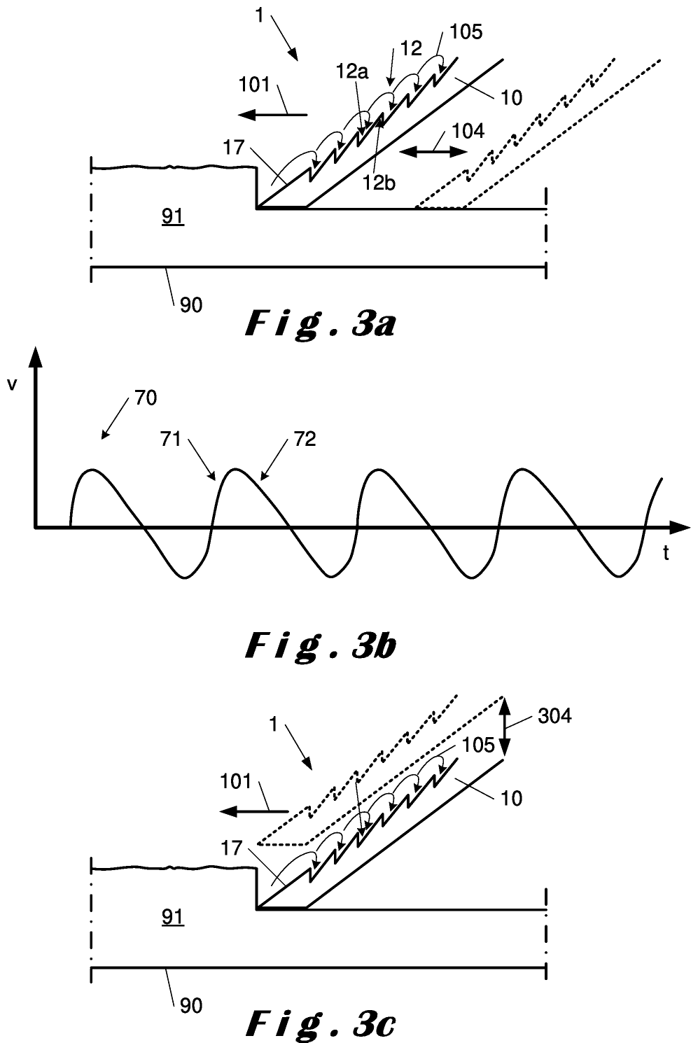

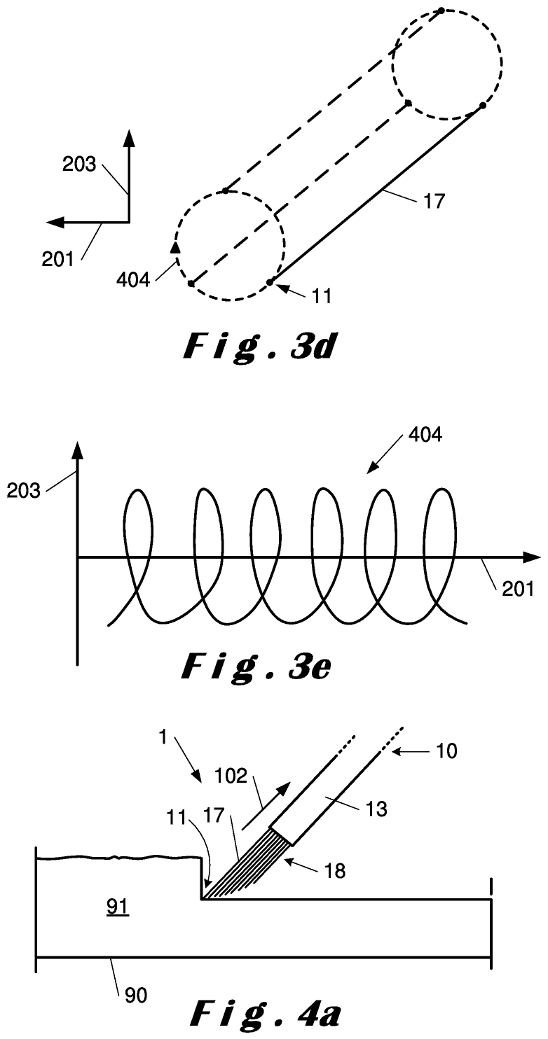

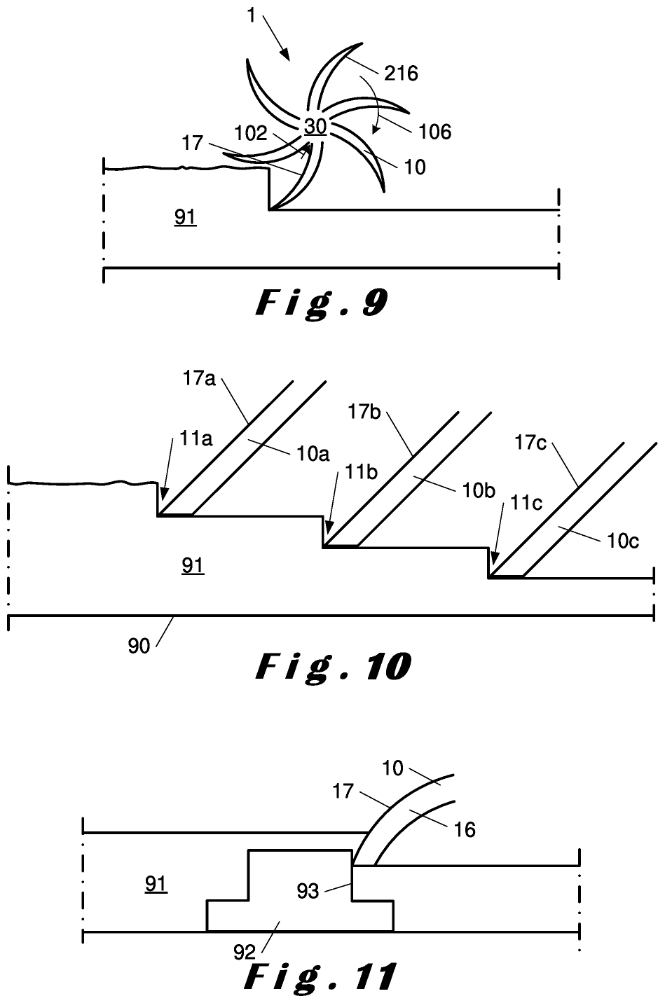

The drive may, for example, be achieved by at least one of the following drive means or driving device: a suction device 30 (FIGS. 1 and 9), a sweeping device 40 (FIG. 2), a mechanism allowing an oscillation 104 of the support surface 17 along the first direction 201 (FIG. 3a), a mechanism allowing an oscillation 304 of the support surface 17 along the third direction 203 (FIG. 3c), a mechanism allowing a combination of oscillations 404 of the support surface 17 along the first 201 and the third 203 direction (FIG. 3d), a magnetic force, an electrostatic force, a mechanical drive (belt, conveyor or Archimedean screw for example, etc.). Several of these driving means can be combined: for example, a sweep of the powder can be followed by a suction, or an oscillation in the first or third direction can be coupled with a suction.

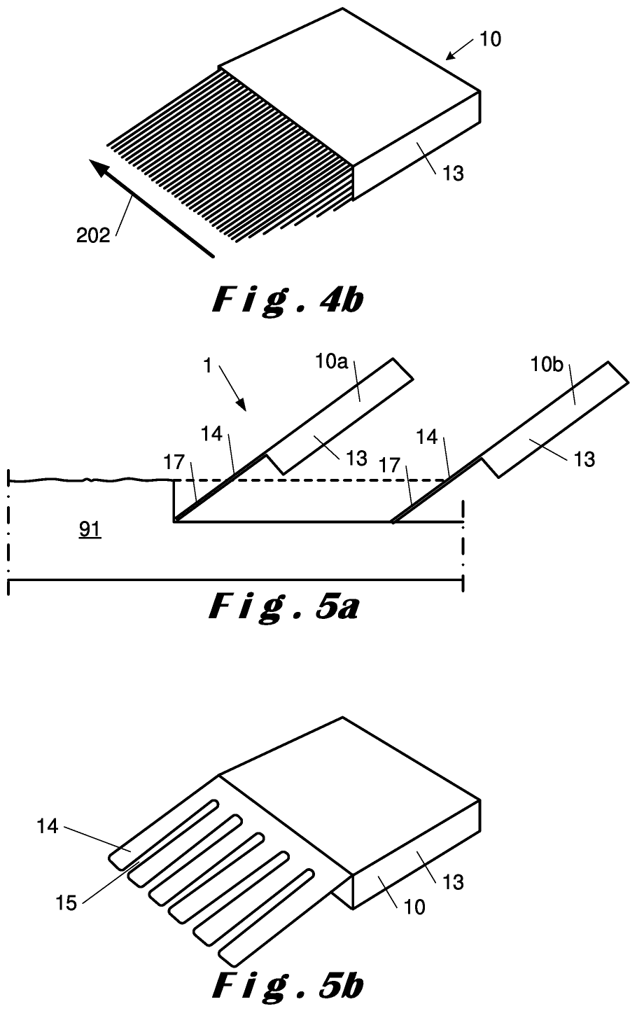

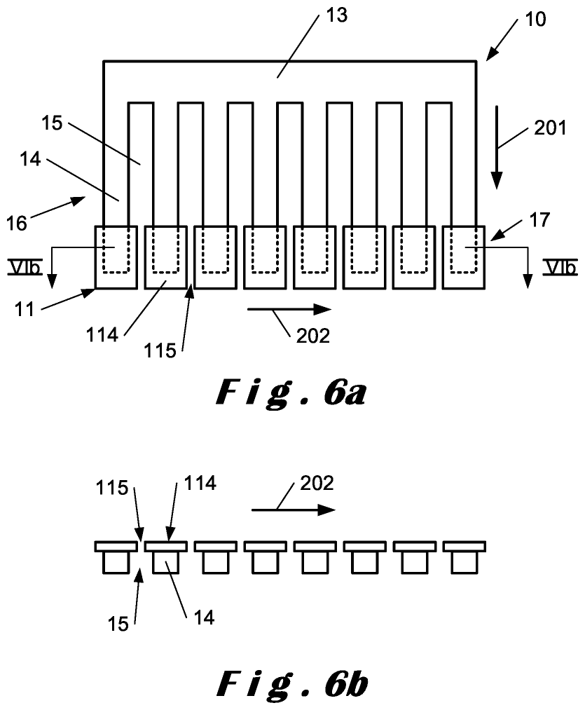

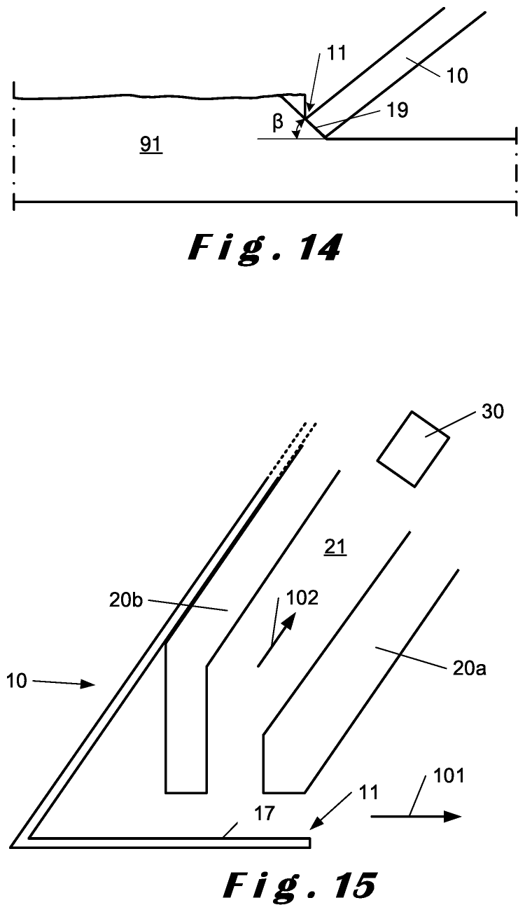

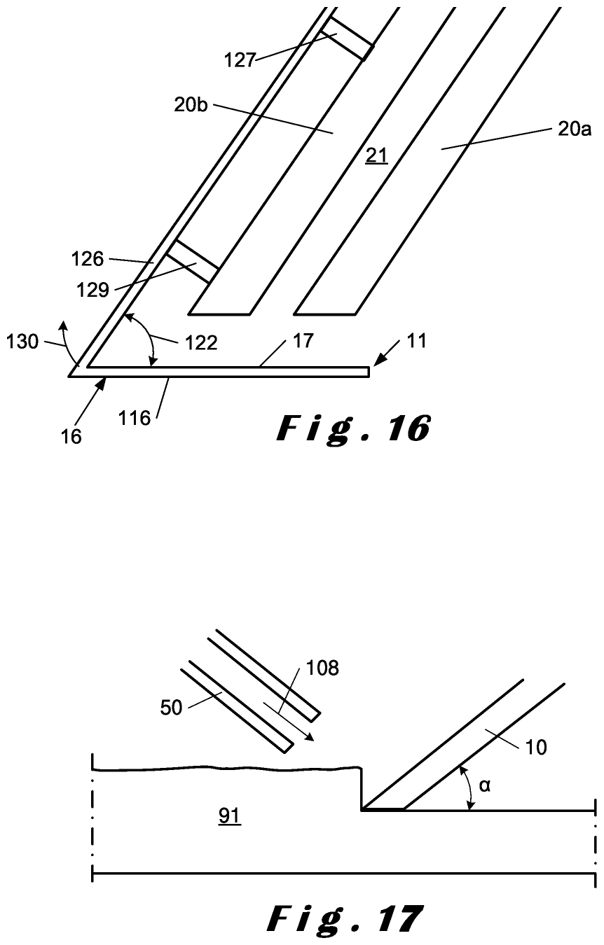

The invention provides several embodiments of the cutting device 10. In particular, the cutting line 11 may be on a portion of the cutting device 10 integral with the rest of the cutting device 10, or on a foldable portion 16 (FIGS. 13a, 13b, 16) of the cutting device 10. This foldable portion 16 may be formed, for example, by two angled portions pivoting together (FIGS. 13a, 13b, 16), by a foldable curved blade 216 (FIGS. 8a, 8b) or by independently foldable elements, such as bristles 18 (FIGS. 4a, 4b), slats 14 (FIGS. 5a, 5b), possibly with extension elements 114 (FIGS. 6a, 6b). In addition, the front-end surface 19 of the cutting device 10, which preferably joins the cutting line 11, may be bevelled in either direction, such as to be horizontal or nearly horizontal (e.g., FIG. 1), or to be perpendicular to the support surface 17 (FIG. 14). Some characteristics of these different embodiments can be combined with each other.

The various embodiments of the cutting device 10 can all be combined with the various embodiments of the drive means. For example, the mechanism allowing the oscillation 104 in the first direction 201 is combinable with a cutting device 10 comprising a foldable curved blade 216, bristles 18, or slats 14; the mechanism allowing the oscillation 304 in the third direction 203 is combinable with a cutting device 10 comprising a foldable curved blade 216, bristles 18, or slats 14; the mechanism allowing the combination of oscillations 404 along the first 201 and the third direction 203 is combinable with a cutting device 10 comprising a foldable curved blade 216, bristles 18, or slats 14; the suction is combinable with a cutting device 10 comprising a foldable curved blade 216, bristles 18, or slats 14.

In one embodiment of the invention, the portion of the cutting device 10 that comprise the cutting line 11 may detach or retract in the event of a collision.

In one embodiment of the invention, the portion of the cutting device 10 that comprises the cutting line 11 is removable. Thus, it can be replaced manually or automatically after or during use.

FIG. 1 illustrates an embodiment of the invention in which the levelling system comprises a guide 20 forming a channel with the cutting device 10. For example, the cutting device 10 and the guide 20 may each comprise a plate parallel to the second direction 202 (i.e., perpendicular to the plane of FIG. 1), with the plates being parallel to each other. The drive system 2, for example comprising a suction device 30, is arranged to drive 102 the powder located between the support surface 17 and the guide 20. The support surface 17 and the guide 20 could be two opposite sides of a nozzle.

FIG. 1 also allows to illustrate an angle α between the cutting device 10 and a horizontal plane. The inventors have found that an angle α between 10° and 15° is a good compromise to prevent the bottom wall of the cutting device 10 from touching the powder at the back of the cutting line while still allowing an efficient cutting. Indeed, an angle α that is too large results in that a portion of the powder is not being cut, but passing under the cutting line 11. An angle α that is too large could also create a compaction of the powder bed and/or a mixture of different particles creating a cross-contamination and/or make it difficult for the powder to be driven close to the cutting line.

FIG. 2 illustrates an embodiment of the invention in which the drive system 2 comprises a sweeping device 40 arranged to push at least one portion of the powder towards the channel between the support surface 17 and the guide 20. The sweeping device 40 preferably comprises a rotating shaft 42 and a plurality of radial elements 41 driven in rotation 103 by the rotating shaft 42. The rotating shaft 42 is preferably parallel to the second direction 202.

FIGS. 3a, 3c and 3d illustrate embodiments of the invention in which the support surface 17 is preferentially arranged to prevent at least one portion of the powder in contact therewith from displacing towards the powder bed 91. To prevent the powder from falling back down towards the powder bed 91, the support surface 17 may, for example, comprise indentations 12 and/or roughness and/or be micro-textured and/or rough and/or have an adequate coefficient of friction with the powder to prevent it from falling back down. The indentations 12 are formed by a succession of hollows 12a and protrusions 12b. The indentations 12 are preferably asymmetrical so that, for powder particles in a hollow 12a, the slope of the protrusion 12b towards the outlet 5 is smaller than the slope of the protrusion 12a towards the powder bed 91.

In the embodiment shown in FIG. 3a, the drive system 2 comprises a mechanism allowing an oscillation 104 of the support surface 1 along the first direction 201. The dotted lines in FIG. 3a illustrate this oscillation 104 along the first direction 201. The oscillation 104 along the first direction 201 progressively advances, or assists in advancing, at least one portion of the powder in contact with the support surface 17 towards the outlet 5, for example by successive jumps 105 between the indentations 12. The oscillation 104 along the first direction 201 has, for example, a velocity along the first direction 201 as illustrated by the curve 70 in FIG. 3b: the velocity v along the first direction 201 increases rapidly 71 and then decreases 72 smoothly with time t. Thus, because the backward motion of the support surface 17 lasts longer than the forward motion, the powder progresses further backward than forward.

In the embodiment shown in FIG. 3c, the drive system 2 comprises a mechanism allowing an oscillation 304 of the support surface 1 along the third direction 203. The dotted lines in FIG. 3c illustrate this oscillation 304 along the first direction 203. The oscillation 304 along the third direction 203 progressively advances, or assists in advancing, at least one portion of the powder in contact with the support surface 17 towards the outlet 5, for example in successive jumps 105.

In the embodiment shown in FIG. 3d, the drive system 2 comprises a mechanism allowing a combination of oscillations 404 of the support surface 17 along the first 201 and third directions 203. FIG. 3d allows to show the support surface 17 at three points during this motion. This motion preferably corresponds to a circular motion of the cutting line 11. FIG. 3e allows to show the evolution of the motion of the cutting line 11 along the third direction 203 according to its position along the first direction 201.

FIGS. 4a and 4b illustrate an embodiment of the invention in which the cutting device 10 comprises a device body 13 and a foldable portion on which the cutting line 11 is located, the foldable portion comprising bristles 18. The bristles 18 are distributed along the second direction 202 and arranged in one or more rows attached across the thickness of the body of the device 13. The length of the bristles 18 preferably decreases downward, which prevents the bristles 18 from touching the surface of the powder bed 91 behind the cutting line 11. FIGS. 4a and 4b are very schematic and the bristles 18 could be much denser.

FIGS. 5a and 5b illustrate an embodiment of the invention in which the cutting device 10 comprises a device body 13 and a foldable portion on which the cutting line 11 is located, the foldable portion comprising slats 14. The slats 14 are distributed along the second direction 202, separated by gaps 15. The levelling system 1 may comprise at least two cutting devices 10a, 10b with slats 14, which follow each other along the first direction 201, with gaps 15 offset along the second direction 202. Thus, powder that was not cut by the first cutting device 10a because of a gap 15 (shown by a dotted line) will be cut by a blade 14 of the subsequent cutting device 10b.

FIGS. 6a and 6b illustrate an alternative embodiment of the invention shown in FIG. 5b. In this embodiment, extension elements 114 are attached to the slats 14 and form the cutting line 11. The extension elements 114 are more extended than the slats 14 along the second direction 202, and thus the gaps 115 between the extension elements 114 are narrower than the gaps 15 between the slats 14. The extension elements 114 are preferably thinner than the slats 14. The extension elements 114 preferentially extend further forward in the first direction 201 than the slats 14, so that the cutting line 11 is formed from the extension elements 114. The extension elements 114 are preferably more flexible than the slats 14. The extension elements 114 may be formed from a strip cut at the level of the gaps 15 between the slats 14. The extension elements 114 preferentially form the support surface 17. The levelling system 1 is preferably arranged so that the powder drive system 2 drives the powder present on the extension elements 114 without it coming into contact with the slats 14. The slats 14 serve as a support allowing a particularly good alignment between the extension elements 114, while allowing upward displacement of the cutting line in the event of a collision with the part.

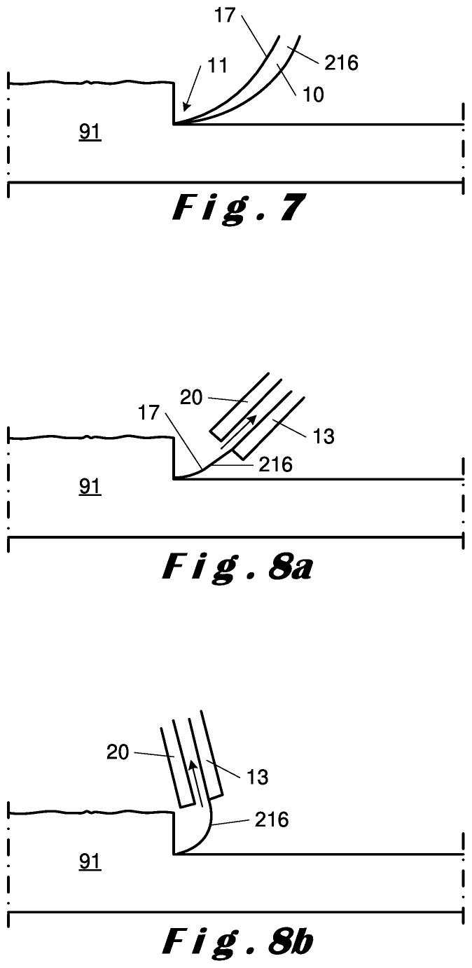

FIG. 7 illustrates an embodiment of the invention in which the cutting device 10 comprises a curved blade 216. This may be integral with the rest of the cutting device 10 or form a foldable portion of the cutting device 10. For example, it can be flexible. It can be made of steel, silicone, carbon or polyurethane. The thickness of the curved blade 216 may decrease as it moves away from the cutting line 11.

FIG. 8a illustrates an embodiment of the invention in which the cutting device 10 comprises a device body 13 and a foldable portion on which the cutting line 11 is located, the foldable portion comprising a curved blade 216. The channel entrance between the guide 20 and the cutting device 10 is located at the rear of the curved blade 216.

FIG. 8b illustrates an embodiment of the invention in which the cutting device 10 comprises a device body 13 and a foldable portion on which the cutting line 11 is located, the foldable portion comprising a curved blade 216. The cutting device 10 is arranged so that the powder in contact with the support surface 17 is driven, at least at some point during its journey towards the outlet 5, forward. This embodiment is particularly advantageous for spreading the curved blade 216 upward in the event of a collision with an obstacle.

FIG. 9 illustrates an embodiment of the invention in which the cutting device 10 comprises a plurality of curved blades 216 arranged in a radius about an axis of rotation. The curved blades 216 rotate 106 about this axis, and the suction device 30, such as a suction nozzle, sucks 102 the powder located in contact with the support surfaces 17 of the curved blades 216. The preceding curved blade 216 thus forms the guide 20 forming a channel with the support surface 17. In addition, the rotation 106 facilitates the drive. The cutting device 10 preferably comprises a guide arranged to prevent the powder from being sprayed out of the powder bed.

FIG. 10 illustrates an embodiment of the invention in which the levelling system 1 comprises a first 10a, a second 10b, and a third 10c cutting device, which may be any cutting device according to any embodiment of the invention. They can be similar or different. The first 10a (respectively second 10b, respectively third 10c) cutting device comprises a first 11a (respectively second 11b, respectively third 11c) cutting line and a first 17a (respectively second 17b, respectively third 17c) support surface. The levelling system 1 may comprise more than three cutting devices.

The second cutting line 11b is lower than the first cutting line 11a, and behind the first cutting line 11a with respect to the displacement of the cutting devices 10a, 10b along the first direction 201. The third cutting line 11c is lower than the second cutting line 11b, and behind the second cutting line 11b with respect to the displacement of the cutting devices 10b, 10c along the first direction 201. The three cutting lines 11a, 11b, 11c are preferably parallel to the second direction 202.

FIG. 11 illustrates an obstacle 92 formed by an object being printed. It can be seen that the foldable portion 16 can bend backwards when it meets the side wall 93 of this obstacle 92.

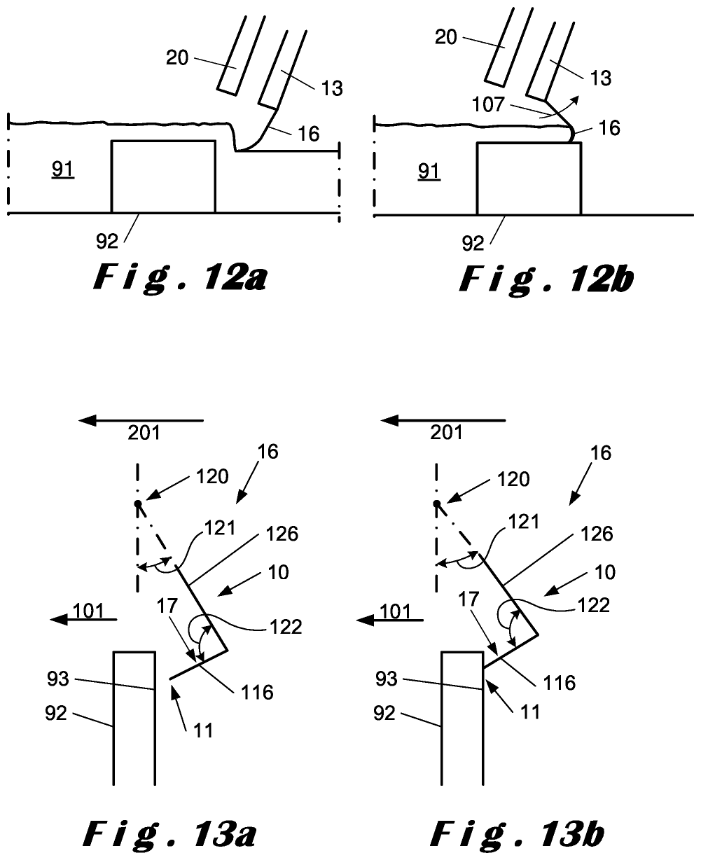

FIGS. 12a and 12b illustrate an embodiment of the invention in which the levelling system 1 is arranged so that the foldable portion scrapes the upper wall of the obstacle 92. FIG. 12a illustrates the situation prior to encountering the obstacle 92 and FIG. 12b illustrates the scraping of the upper surface of the obstacle 92. Indeed, the foldable portion is arranged to fold 107 or pivot so that the cutting line 11 rises when the cutting line 11 encounters an obstacle 92.

FIGS. 13a and 13b illustrate an embodiment of the invention in which the cutting device 10 comprises a foldable portion 16, which comprises a first portion 116 and a second portion 126 forming an angle 122 with the first portion 116. The cutting line 11 is on the first portion 116. The cutting device 10 is arranged so that the foldable portion 16 pivots about a pivot 120 located in front of the cutting line 11. In such a case, when the cutting line 11 encounters the obstacle 92, the angle 121 between the vertical and the second portion 126 increases as the cutting device 10 pivots backward, while the angle 122 between the first portion 116 and the second portion 126 remains preferentially constant. This allows the cutting line 11 to be raised to avoid damage to the obstacle 92. FIG. 13a illustrates the situation before the encounter with the obstacle 92 and FIG. 13b illustrates the raising of the cutting line 11 upon encounter with the obstacle 92.

FIG. 14 allows to illustrate an angle β between the front-end surface 19 of the cutting device 10 and the horizontal. The angle β may be such that the front-end surface 19 is bevelled in one direction, in the other direction, or forms a right angle with the support surface 17. If the angle β is between 0 and 90°, the front-end surface 19 compresses the remaining powder on the powder bed 91, thereby allowing to improve its density.

FIG. 15 illustrates an embodiment of the invention in which the guide 20 comprises two parts 20a, 20b, separated by a channel 21 opening towards the support surface 17.

FIG. 16 illustrates an embodiment of the invention combining certain characteristics of the embodiments of FIGS. 5b, 13a and 13b, and 15. The guide 20 comprises two parts 20a, 20b, separated by a channel 21 opening towards the support surface 17. The cutting device 10 comprises a foldable portion 16 comprising a first portion 116 and a second portion 126 a corner 122. The first portion 116 and the second portion 126 are for example made of slats 14, which are attached to the guide 20 by an attachment element 127. Before encountering an obstacle, the second portion 126 rests, at least partially, on a lug 129 attached to a portion of the guide 20b. When the first portion 116 encounters an obstacle, as shown in FIGS. 13a, 13b, the second portion 126 moves back and up (arrow 130) and away from the lug 129. After the obstacle, the second portion 126 returns to contact the lug 129 by elastic return. Thus, the lug 129 allows the second portion 126 to return to a precise position, and thus allows a particularly precise positioning of the cutting line 11. The embodiment shown in FIG. 16 is particularly well suited to be arranged as shown in FIGS. 13a and 13b.

FIG. 17 illustrates an embodiment of the invention in which the levelling system 1 comprises a blower 50 arranged to blow 108, for example air, onto the powder in the powder bed 91 and/or onto the powder in contact with the support surface 17.

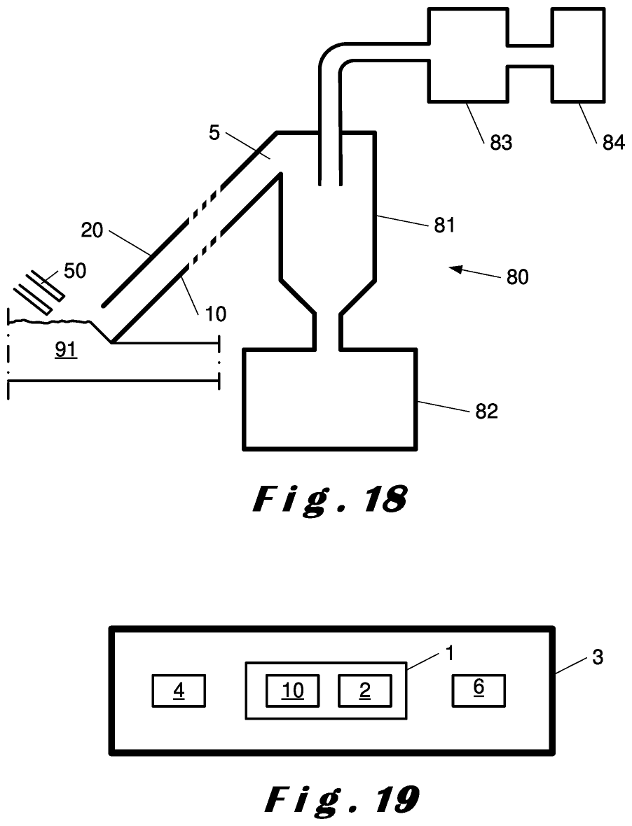

FIG. 18 illustrates an embodiment of the invention in which the outlet 5 opens to a powder recycling system 80 comprising a cyclone 81 connected, on the one hand, to a reservoir 82 and, on the other hand, to a fan 83 itself connected to a filter 84. Such a powder recycling system 80 forms a suction device 30 allowing to drive the powder into contact with the support surface 17. It allows to recover the powder in relation to the air flow. FIG. 18 is not to scale.

FIG. 19 depicts a three-dimensional printing system 3 according to one embodiment of the invention. It comprises a deposition device 4 arranged to deposit a powder so as to form a powder bed 91, a levelling system 1 as described herein and arranged to level said powder bed 91, with a cutting device 10 and a drive system 2, and an agglomerating means 6 arranged to agglomerate at least one portion of the powder bed 91 after levelling. Optionally, after levelling, the powder bed 91 can be compacted, for example by a compaction roller.

The levelling system 1 can be located in front of or behind the deposition device 4. If the deposition device 4 comprises a rotating roller, for example as described in the documents WO2018059833, the axis of this roller may be parallel to the second direction 202, or may not be.

Any motion of the cutting device 10 relative to the powder bed 91 is possible while remaining within the scope of the invention. For example, this motion could comprise a combination of translations in the first 201 and the second 202 directions. It could also comprise a rotation along a vertical axis.

In one embodiment of the invention, the levelling system 1 and the deposition device 4 are stationary and the support 90 of the powder bed 91 displaces along the first direction 101.

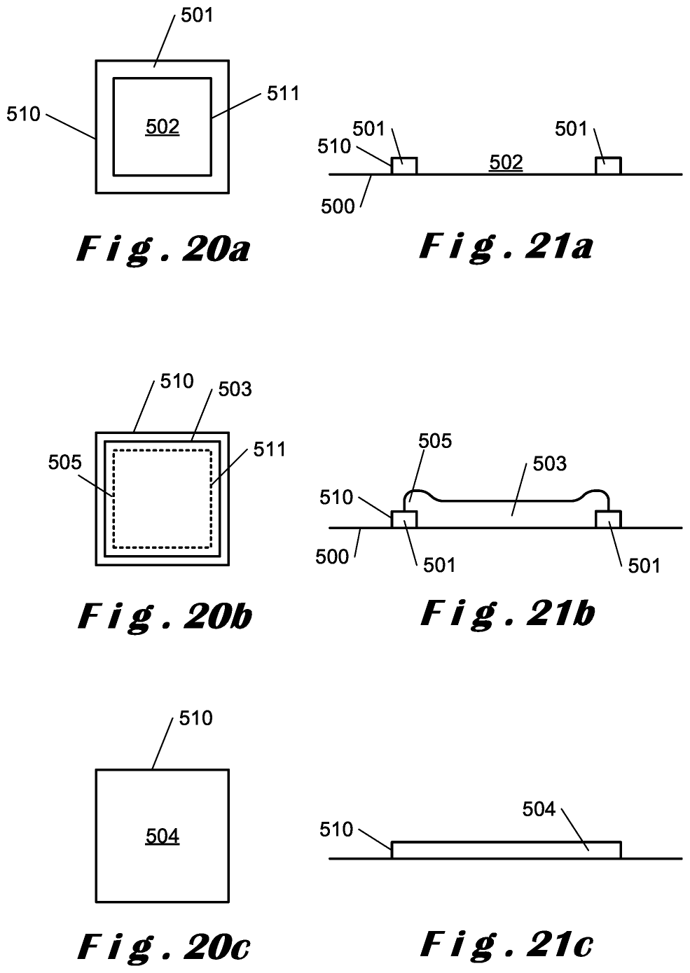

FIGS. 20a-c and 21a-c illustrate a method for using a levelling system to level a powder bed. This method can be used with the levelling system 1 according to the invention or another levelling system. FIGS. 20a and 21a show a first deposition of powder on a support 500, with a first definition, which deposits a first portion 501 of the desired shape. In the illustrated example, the first portion 501 is an outline surrounding a hole 502.

FIGS. 20b and 21b show a second deposition of powder on the support 500, with a second definition, which deposits a second portion 503, for example a filling of said hole 502. The second definition is weaker than the first. The second portion 503 overlaps the first portion 501 to avoid the powder-free areas. In other words, the second portion 503 overlaps, partially and not totally, with the first portion 501. Thus, in the case of an outline, the second portion 503 is less extensive than the outer perimeter 510 of the outline, and more extensive than the inner perimeter 511 of the outline.

FIGS. 20c and 21c show the result of a levelling of the first 501 and the second 503 portions: the desired shape 504 with a flat upper surface is obtained.

The method allows to provide a high definition shape 504 on the non-overlapping portions (in the illustrated example, the outer perimeter definition 510 is the first definition) deposited quickly (in the illustrated example, the central portion is deposited with the second definition which allows a faster deposition). This method is also particularly suitable for depositing a first portion 501 formed by islands, excrescences, or any pattern requiring a high definition, i.e. particularly fine portions.

In one embodiment of the invention, the first powder deposit deposits a first powder, and the second powder deposit deposits a second powder, different from the first powder. For example, the first and the second powders can be made of different materials. A levelling can be provided between the first and the second deposits

FIG. 22 illustrates a method for forming 220 a powder structure comprising two powders, according to one embodiment of the invention. The arrow 901 indicates the direction of the motion of the horizontal support 90. A first powder 610 is deposited 221 using a first deposition device 611, so as to form a first portion 91a of powder bed. The first portion 91a of powder bed preferably comprises holes. Next, a first levelling system 1a, according to one or another embodiment of the invention, cuts 222 the upper portion of the first portion 91a of powder bed. The first cut powder 610 can be recovered. The first levelling system 1a has a cutting line 11a located at a height H from the support 90.

A second powder 620 is then deposited 222 using a second deposition device 621, so as to form a second portion 91b of powder bed. The second portion 91b of powder bed at least partially fills some of the holes in the first portion 91a of powder bed. It preferentially forms overlaps 91c with the first portion 91a of powder bed. Next, a second levelling system 1b, according to one or another embodiment of the invention, cuts 224 the upper portion of the second portion 91b of powder bed and the overlays 91c.

The cutting line 11b of the second levelling system 1b is preferably located at substantially the same height H relative to the support 90 as the cutting line 11a of the first levelling system 1a. This allows to result in a final structure without overlapping. The disadvantage is that the levelling by the second levelling system 1b recovers a mixture of first 610 and second 611 powders. If it is desired to recover that the second powder 611 unmixed with the first powder 610, it is preferable that the cutting line 11b of the second levelling system 1b is higher than the cutting line 11a of the first levelling system 1a.

The method illustrated in FIG. 22 can be summarized as follows: method for forming 220 a powder structure comprising, in this order:
a deposit 221, using a first deposition device 611, a first powder 610 to form a first portion 91a of powder bed,
a levelling 222 of the first portion 91a of powder bed using a first levelling system 1a,
a deposit 223, using a second deposition device 621, a second powder 621 to form a second portion 91b of powder bed, and
a levelling 224 of the second portion 91b of powder bed using a second levelling system 1b,
wherein the levelling 222 of the first portion 91a of powder bed and the levelling 224 of the second portion 91b of powder bed are vertically aligned.

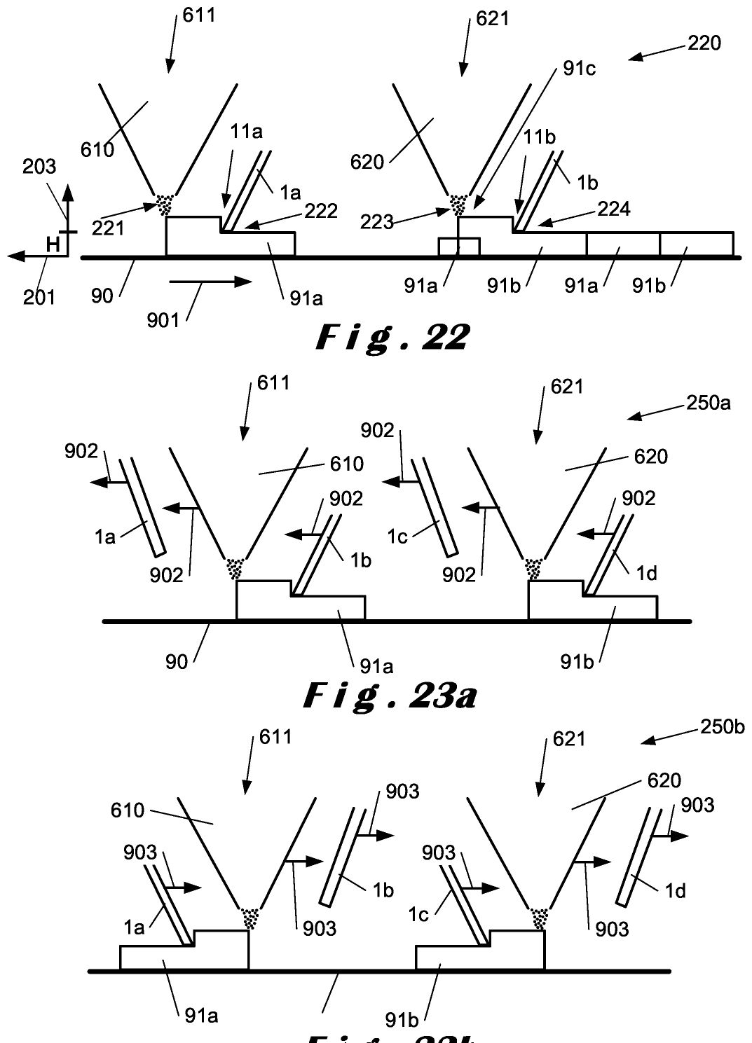

FIGS. 23a, 23b illustrate a method for forming 250a, 250b a powder structure, according to one embodiment of the invention. In a first step 250a, a first deposition device 611, a first levelling system 1a, and a second levelling system 1b (with potentially a second deposition device 621, a third levelling system 1c, and a fourth levelling system 1d) are displaced in a first direction 902. The second 1b (respectively fourth 1d) levelling system is located opposite the first 1a (respectively third 1c) levelling system with respect to the first 611 (respectively second 621) deposition device. The second 1b (respectively fourth 1d) levelling system is lower than the first 1a (respectively third 1c) levelling system when displacing in the first direction 902. Thus, the second 1b (respectively fourth 1d) levelling system comes into contact with the first 91a (respectively second 91b) portion of powder bed, which is deposited by the first 611 (respectively second 621) deposition device, while the first 1a (respectively third 1c) levelling system does not come into contact with the first 91a (respectively second 91b) portion of powder bed.

In a second step 250b, the first deposition device 611, the first levelling system 1a, and the second levelling system 1b (potentially with the second deposition device 621, the third levelling system 1c, and the fourth levelling system 1d) are displaced in a second direction 903 opposite the first direction 902. Compared to the first step 250a, the second 1b (respectively fourth 1d) levelling system is lowered, and the first 1a (respectively third 1c) levelling system is raised, so that the second 1b (respectively fourth 1d) levelling system is higher than the first 1a (respectively third 1c) levelling system when displacing in the second direction 603. Thus, the second 1b (respectively fourth 1d) levelling system does not come into contact with the first 91a (respectively second 91b) portion of powder bed, whereas the first 1a (respectively third 1c) levelling system comes into contact with the first 91a (respectively second 91b) portion of powder bed.

The first 611 and second 621 deposition devices shown in FIGS. 22, 23a, 23b may be any or each involve a roller, for example as described in the document PCT/EP2017/071039. In the methods described with reference to these figures, it is possible for the support 90 to displace 901, just as it is possible for the deposition devices 611, 621, and the levelling systems 1a-d to displace 902, 903.

In other words, the invention relates to a system and a method for levelling a powder bed 91. The system comprises a cutting device 10 comprising a cutting line 11 and a support surface 17. The powder bed 91 is cut by the cutting line 11 which displaces along a first direction 201 so that the cut powder comes into contact with the support surface 17, where it is driven towards an outlet 5 by a powder drive system. The present invention can in particular be used in any system or method involving a powder bed or a deposition of a powder coating on any substrate (glass, boards, sheets, tiles, vinyl, etc.).

The present invention has been described above in relation with specific embodiments, which are purely illustrative and should not be considered limiting. In a general manner, the present invention is not limited to the examples illustrated and/or described above. The use of the verbs “comprise”, “include”, or any other variant, as well as their conjugations, can in no way exclude the presence of elements other than those mentioned. The use of the indefinite article “a”, “an”, or the definite article “the”, to introduce an element does not exclude the presence of a plurality of these elements. The reference numbers in the claims do not limit their scope.

1. A system comprising:
a deposition device arranged to deposit a plurality of powders at selected locations, so as to form a powder bed comprising different powders,
a levelling system for levelling the powder bed, and comprising:
a cutting device comprising a cutting line and a support surface, the cutting line being mechanically coupled to the support surface and arranged to cut the powder bed so that the cut powder comes into contact with the support surface when the cutting device is displaced in a first direction relative to the powder bed, and
a powder drive system arranged so as to drive the powder in contact with the support surface towards an outlet.

2. The system of claim 1, wherein the levelling system further comprises a guide located at least partially opposite the support surface and arranged to channel at least one portion of the plurality of powders into contact with the support surface as it travels towards the outlet.

3. The system of claim 1, wherein the powder drive system comprises a suction device arranged to suck at least one portion of the plurality of powders in contact with the support surface towards the outlet.

4. The system of claim 1, wherein the powder drive system comprises a sweeping device arranged to push at least one portion of the plurality of powders in contact with the support surface towards the outlet.

5. The system of claim 1, wherein the powder drive system comprises a mechanism for allowing a combination of oscillations along the first and a third direction of the support surface, the third direction being vertical.

6. The system of claim 1, wherein the cutting device comprises a foldable portion on which the cutting line and at least one portion of the support surface are located.

7. The system of claim 6, wherein the foldable portion comprises a first portion on which the cutting line and at least one portion of the support surface are located, and a second portion forming a non-zero angle, preferably an acute angle, with the first portion, the cutting device being arranged so that the foldable portion is adapted to pivot about a pivot located forward of the cutting line relative to the displacement of the cutting device.

8. The system of claim 6, wherein the foldable portion comprises independently foldable elements, for example bristles or slats, distributed along a second direction perpendicular to the first direction and horizontal.

9. The system of claim 8, wherein the independently foldable elements are slats, to which are attached extension elements forming the cutting line, the extension elements being more extended than the slats along the second direction and being more flexible than the slats.

10. The levelling system of claim 1, further comprising a blower arranged to blow on the plurality of powders of the powder bed and/or on the plurality of powders in contact with the support surface.

11. The system of claim 1, wherein the cutting device is a first cutting device, the cutting line is a first cutting line, and the support surface is a first support surface,
the levelling system further comprising a second cutting device comprising a second cutting line and a second support surface,
the second cutting line being arranged to cut the powder bed so that the cut powder comes into contact with the second support surface when the second cutting device is displaced in the first direction relative to the powder bed,
the second cutting line being lower than the first cutting line, behind the first cutting line with respect to the displacement of the cutting devices, and preferably parallel to the first cutting line.

12. The system of claim 1, being a three-dimensional printing system comprising
an agglomerating means arranged to agglomerate at least one portion of the powder bed after the powder bed has been levelled by the levelling system.

13. (canceled)

14. A method comprising the steps of:
depositing, with a deposition device, a plurality of powders at selected locations, so as to form a powder bed comprising different powders,
providing a cutting device comprising a cutting line and a support surface, the cutting line being mechanically coupled to the support surface,
cutting the powder bed with the cutting line by displacing the cutting device in a first direction relative to the powder bed so that the cut powder comes into contact with the support surface, and
driving the powder into contact with the support surface towards an outlet.

15. A method for creating a powder shape comprising, in this order:
a first powder deposit, with a first definition, to form a first portion of the powder shape,
a second powder deposit, with a second definition lower than the first definition, to form a second portion of the powder shape, which is partially superimposed on the first portion of the powder shape, and
a levelling, of the second portion of the powder shape superimposed on the first portion of the powder shape, using a levelling system comprising:
a cutting device comprising a cutting line and a support surface, the cutting line being mechanically coupled to the support surface, and
a powder drive system arranged so as to drive the powders in contact with the support surface towards an outlet.

16. The method of claim 13, wherein the powders differ in their chemical composition and/or have different materials and/or different particle sizes.

17. The system of claim 7, wherein the foldable portion comprises independently foldable elements, for example bristles or slats, distributed along a second direction perpendicular to the first direction and horizontal.

18. The system of claim 2, wherein the powder drive system comprises a suction device arranged to suck at least one portion of the plurality of powders in contact with the support surface towards the outlet.
